(19) United States
(12) Patent Application Publication
(10) Pub. No.: US 2025/0019994 A1
(43) Pub. Date: Jan. 16, 2025

(54) APPARATUS AND METHOD FOR FORMING A RECESS IN A DOOR FRAME

(71) Applicant: Simon Brown, Leigh Lancashire (GB)

(72) Inventor: Simon Brown, Leigh Lancashire (GB)

(21) Appl. No.: 18/220,903

(22) Filed: Jul. 12, 2023

(51) Int. Cl. E05B 17/06; B27F 5/12

(52) U.S. Cl. CPC E05B 17/06; B27F 5/12

(57) ABSTRACT

An adjustable door keep jig includes a spine extending in a first direction, first and second spaced apart body elements extending from the spine in a second direction, and a first leg extending from the first body element toward the second body element in the first direction. The first leg is adjustable relative to the first body element in both the first and second directions. A second leg extends from the second body element toward the first body element in the first direction and is adjustable relative to the second body element in both the first and second directions. The spine, the first and second body elements, and the first and second legs define an opening that provides a guide for a cutting tool to form the recess in a surface of the door frame when the door keep jig is placed against the door frame.

### BACKGROUND OF THE INVENTION

The present disclosure relates to an adjustable jig and is particularly, although not exclusively, concerned with an adjustable door keep jig for use in cutting a recess for a door keep in a door frame.

It is common in carpentry and similar industries to cut a recess in a surface, e.g., for receiving a component such as an insert. The dimensions, including the depth, of such recesses can vary widely, with some having re-entrants and internal sub-recesses. It is therefore common for recesses to be formed freehand or artisanally, e.g. using a hammer and a chisel. However, such methods may be imprecise, and lack repeatability and/or speed.

For example, when fitting a door keep (also strike plate or lock keep) of a door latch assembly to the jamb of a doorframe, it is common for a recess to be cut into the surface of the jamb in order to receive the door keep. This allows the door keep to sit flush with the surface of the doorframe. However, the recess tends to be cut using a hammer and a chisel, meaning that the dimensions of the recess may not uniformly match those of the door keep, leading to suboptimal appearance and performance.

It would therefore be desirable to provide a means for cutting a recess in a surface which is repeatable, precise, and/or fast. Further, it would be advantageous to provide a means (e.g., a single apparatus) for cutting a recess that is adjustable so as to be capable of cutting recesses having varying shapes, sizes, and other characteristics, rather than requiring a vast array of templates of varying shapes and sizes. The present disclosure aims to better address one or more of these concerns.

The present inventor has determined that a recess for a door keep may be considered unusual, as the recess often comprises a complex shape (e.g., comprising at least one re-entrant and/or comprising sub-shapes or sub-recesses), part of which may intersect or extend over an edge of the jamb of the door frame. Further, the boundaries of a recess for a door keep tend to remain visible after installation of the door keep.

### SUMMARY OF THE INVENTION

According to an aspect of the present disclosure, there is provided an adjustable jig for use in cutting a recess for a door keep in a door frame, the jig comprising: a spine extending in a first direction; a first body element and a second body element each being connected to the spine and each extending away from the spine in a second direction, the first and second body elements being spaced apart from one another; and a first leg slidably connected to the first body element and extending from the first body element toward the second body element in the first direction, the first leg being slidably adjustable relative to the first body element in the second direction, wherein the spine, the first and second body elements, and the first leg at least partially define therebetween an opening, the opening providing a guide for a cutting tool to form the recess in the surface when the door keep jig is placed against the door frame within which the recess is to be cut.

The first and second directions may be perpendicular. A third direction may be defined perpendicular to the first and second directions.

The first leg may be slidably adjustable relative to the first body element along the first and second directions independently. At a proximal end of the first leg, the first leg may comprise a first foot extending away from the spine in the second direction.

The jig may comprise a second leg slidably connected to the second body element and extending from the second body element toward the first body element in the first direction, the second leg being slidably adjustable along the second body element in the second direction. The second leg may be slidably adjustable relative to the second body element along the first and second directions independently. The second leg may comprise a second foot extending away from the spine in the second direction.

The first and second legs may be slidably adjustable independently of one another.

According to another aspect of the present disclosure, there is provided an adjustable door keep jig for use in cutting a recess for a door keep in a door frame, the door keep jig comprising: a spine extending in a first direction; a first body element and a second body element each being connected to the spine and each extending away from the spine in a second direction, the first and second body elements being spaced apart from one another; a first leg slidably connected to the first body element and extending from the first body element toward the second body element in the first direction, the first leg being slidably adjustable relative to the first body element in both the first and second directions; and a second leg slidably connected to the second body element and extending from the second body element toward the first body element in the first direction, the second leg being slidably adjustable relative to the second body element in both the first and second directions, wherein the spine, the first and second body elements, and the first and second legs at least partially (e.g., define or at least partially delineate) therebetween an opening, the opening providing a guide for a cutting tool to form the recess in the surface when the door keep jig is placed against the door frame within which the recess is to be cut.

The first and second body elements may be slidably adjustable along the spine in the first direction.

At a proximal end of the first leg, the first leg may comprise a first foot extending away from the spine in the second direction. At a proximal end of the second leg, the second leg may comprise a second foot extending away from the spine in the second direction.

The first leg may be slidably adjustable relative to the first body element along the first and second directions independently. The second leg may be slidably adjustable relative to the second body element along the first and second directions independently.

The first and second legs may be slidably adjustable independently of one another.

The opening may comprise a re-entrant (e.g., a re-entrant angle or re-entrant corner). The first foot and the first leg may be configured to define a first re-entrant of the opening. The second foot and the second leg may be configured to define a second re-entrant of the opening.

The first and second body elements may be configured to be spaced apart along the first direction to define a first dimension of the opening. The first leg may be configured to be spaced apart from the spine in the second direction to define a second dimension of the opening.

A separation between the first and second feet along the first direction may be configured to be continuously variable between zero and a separation between the first and second body elements along the first direction.

The first foot and/or the second foot may be configured to define a shape of the opening and a further dimension of the opening.

The first and second body elements may be lockable relative to the spine. The first leg may be lockable relative to the first body element. The second leg may be lockable relative to the second body element.

The first foot may be rigidly attached to the first leg. The second foot may be rigidly attached to the second leg.

The jig may be configured (e.g., in use) to be coupled to the door frame.

Each of the first and second body elements may comprise an aperture for receiving a fastener for fixing the jig to the door frame.

The first and second body elements may be continuously adjustable relative to the spine. The first and second legs may be continuously adjustable relative to the first and second body elements respectively.

Upon coupling to the doorframe, at least one of the first and second feet may be configured to extend away from the spine in the second direction and beyond an edge of the door frame (e.g., a side edge or aspect of the jamb of the door frame). The jig may configured to form a recess intersecting an edge of the door frame (e.g., a side edge or aspect of the jamb of the door frame).

The jig may be configured to be placed against the door frame so as to extend across (e.g., bridge or span) the stop and the jamb of the door frame. The first and second body elements (e.g., a bottom surface thereof) may be configured to abut a surface of the door frame (e.g., the jamb). The first and second body elements (e.g., a lateral surface thereof) may be configured to abut a side surface of the stop of the door frame. The spine may be configured to abut the stop of the door frame. A bottom surface of the spine and a bottom surface of one or both of the first and second body elements may be spaced apart in a third direction (e.g., perpendicular to said surfaces).

The jig may be configured to define a shape of the opening from one of: rectangular shaped; L-shaped; T-shaped; and three-sided rectangular shaped, openings. The opening may be configured to define a simple shape. The opening may be configured to define a complex shape.

The recess may be configured to receive a door keep.

According to another aspect of the present disclosure, there is provided a door frame comprising a recess formed using the door keep jig.

According to another aspect of the present disclosure there is provided a method of forming a recess for a door keep in a door frame, the method comprising: coupling the door keep jig according to the door frame; adjusting the first and second legs so that the opening corresponds to the door keep; and using the opening, defined by at least the spine, the first and second body elements and the first leg, to guide the cutting tool and form the recess.

The method may further comprise at least one of: inserting a door keep within the opening of the jig; setting the first, second and/or further dimensions of the opening to match corresponding dimensions of the door keep; locking the jig components; fixing the jig to the surface; cutting a recess in the surface; removing the jig from the surface; and fitting the door keep within the recess.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a front view of an exemplary door keep jig defining a rectangular opening.

FIG. 2 is a side perspective view of an exemplary door keep jig defining a T-shaped opening.

FIG. 3 is a front view of the door keep jig of FIG. 2 having been used to form a T-shaped recess in a door frame.

FIG. 4 is a front view of a T-shaped recess formed in a door frame using a door keep jig of the present disclosure.

FIG. 5 is a front view of a door keep fitted to the recess of FIG. 4.

FIG. 6 is a flow chart showing an exemplary method according to the present disclosure.

### DETAILED DESCRIPTION OF THE PREFERRED EMBODIMENT

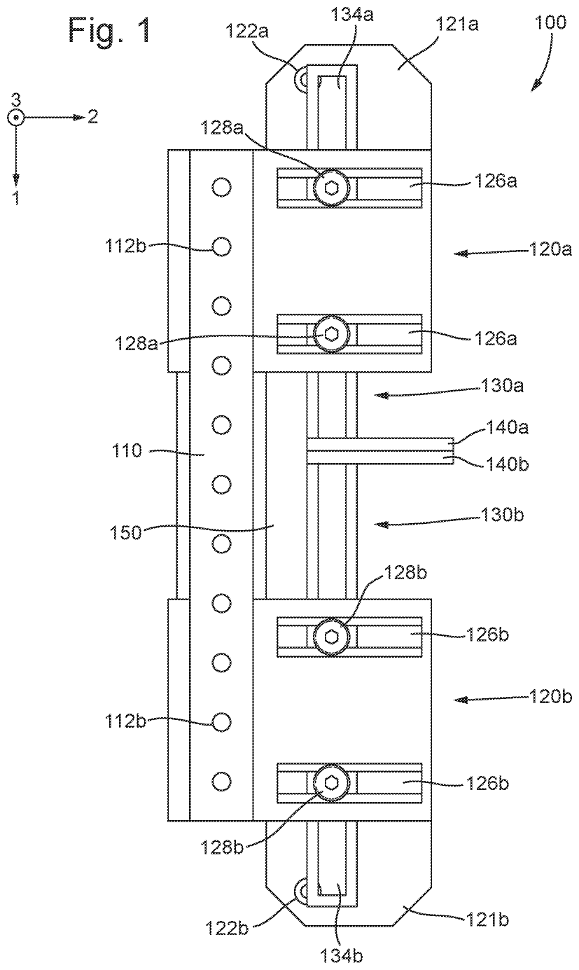

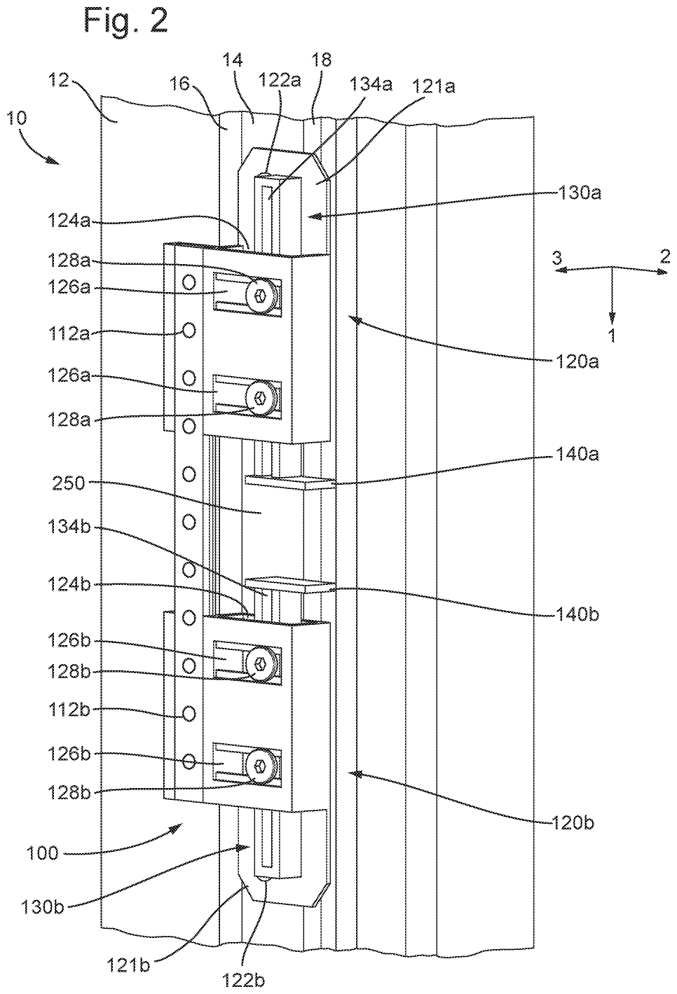

With reference to FIG. 1, a jig 100 is described. The jig 100 is suitable for use in cutting a recess in a surface against which the jig 100 may be placed. In particular, the jig 100 is suitable for use in cutting a recess for a door keep (also a strike plate or lock keep) in a door frame 10 (FIG. 2).

Although the jig 100 will generally be described in the context of cutting a recess in a door frame for a door keep, it will be understood that the jig 100 may equally be suitable for cutting recesses with different purposes. For example, the jig 100 may additionally be suitable for use in cutting a recess for a door hinge in a door frame 10 and/or suitable for use in cutting a recess in a door for receiving a door handle assembly or a door latch assembly.

The jig 100 comprises a spine 110, a first body element 120a, and a second body element 120b. The spine 110 comprises an elongate member extending linearly with a substantially uniform (e.g. a uniform) transverse cross section. A longitudinal axis of the spine 110 defines a first direction 1 of the jig 100. A second direction 2 of the jig 100 is defined perpendicular to the first direction 1 such that, in use, the first and second directions 1, 2 are parallel with the plane of the surface of the door jamb 14 (FIG. 2) in which a recess is to be cut using the jig 100. A third direction 3 of the jig is defined perpendicular to the first and second directions 1, 2 (out of the page in FIG. 1).

The spine 110 may be substantially planar such that its length (along the first direction 1) and width (along the second direction 2) are substantially greater than its thickness (along the third direction 3). Alternatively, the spine 110 may not be planar. In the example shown in FIG. 1, a bottom (along the third direction 3) surface of the spine 110 (in the plane of the page) is substantially parallel with a top surface of the spine 110 (in the plane of the page), such that the spine 110 may resemble a standard ruler. The top surface of the spine 110 may be marked with distance measurements (not shown) to aid a user in making precise adjustments.

The first body element 120a and the second body element 120b are connected to the spine 110 and extend away from the spine 110 along the second direction (i.e., perpendicularly therefrom). For example, the first and second body elements 120a, 120b may be fixedly (e.g. rigidly) or slidably connected to the spine 110. In the example shown in FIG. 1, a top surface (parallel with the first and second directions 1, 2) of each of the first and second body elements 120a, 120b is substantially coplanar with the top surface of the spine 110. Accordingly, the spine 110, and the first and second body elements 120a, 120b form a contiguous top surface. Although not visible in FIG. 1, it should be apparent from the perspective of FIG. 2 that, although the top surfaces of the spine 110 and the first and second body elements 120a, 120b may be substantially coplanar, their bottom surfaces may be spaced apart in the third direction 3.

The jig 100 further comprises a first leg 130a being slidably connected to the first body element 120a. The first leg 130a extends from the first body element 120a toward the second body element 120b along the first direction 1. At a proximal end of the first leg 130a, the first leg 130a comprises a first foot 140a. The first foot 140a extends along the second direction 2 away from the spine 110 such that the first foot 140a protrudes laterally beyond the first leg 130a along the second direction 2. On an aspect closest to the spine 110, the first leg 130a and the first foot 140a form a contiguous surface along the first direction 1.

The jig 100 further comprises a second leg 130b slidably connected to the second body element 120b. The second leg 130b extends from the second body element 120b toward the first body element 120a along the first direction 1. At a proximal end of the second leg 130b, the second leg 130b comprises a second foot 140b. The second foot 140b extends along the second direction 2 away from the spine 110 such that the second foot 140b protrudes laterally beyond the second leg 130b along the second direction 2. On an aspect closest to the spine 110, the second leg 130b and the second foot 140b form a contiguous surface along the first direction 1.

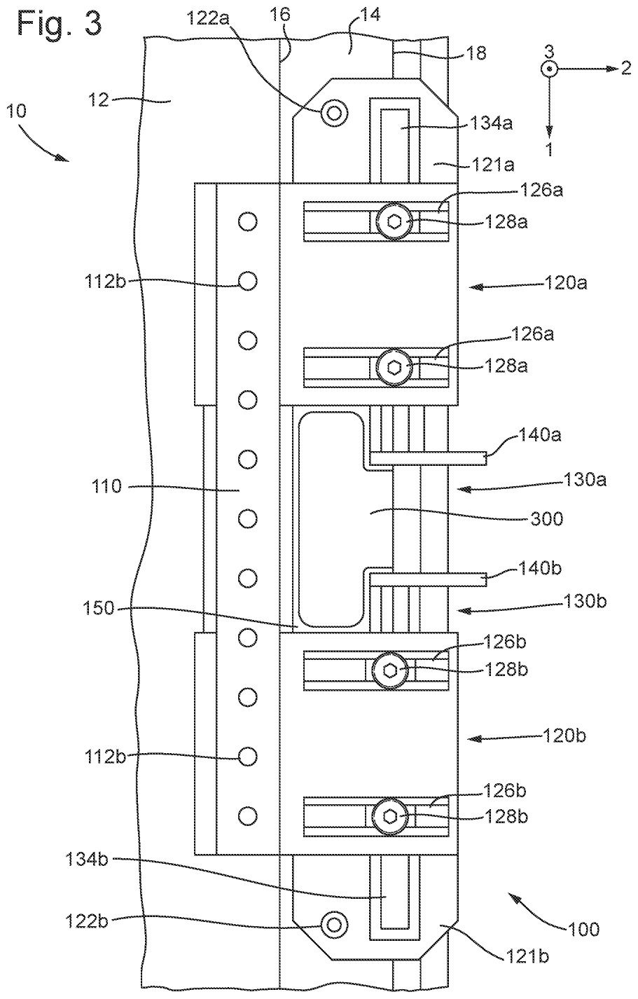

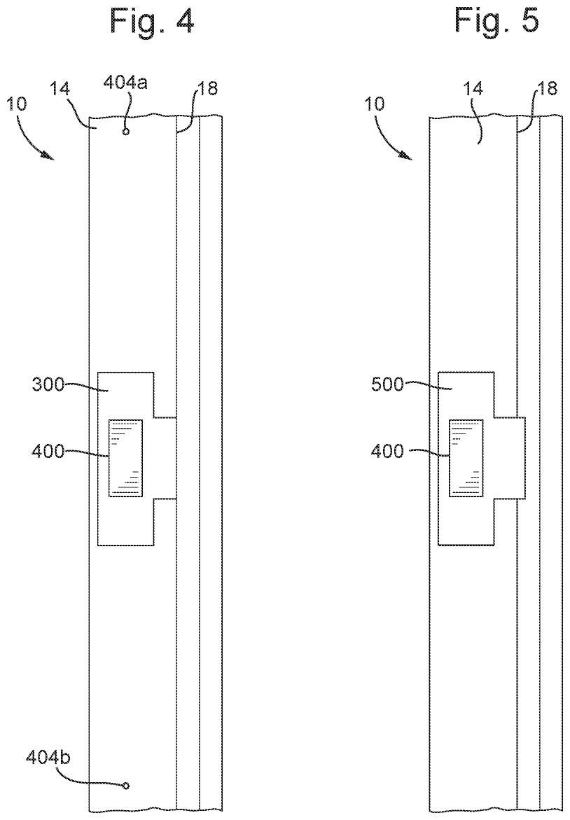

The spine 110 and the first and second body elements 120a, 120b at least partially define therebetween (e.g., define therebetween or at least partially delineate or define at least three sides of) an opening 150. In the example shown in FIG. 1, the spine 110, the first and second body elements 120a, 120b, and the first and second legs 130a, 130b define therebetween a rectangular opening 150. The opening 150 is configured to receive and guide a cutting tool (not shown) to form a recess 200 (FIGS. 3 and 4) in a surface against which the jig 100 may be placed. As will be described later, the opening 150 may comprise varying dimensions and shapes depending on the position of the first and second body elements 120a, 120b, and the first and second legs 130a, 130b, including the first and second feet 140a, 140b.

Although not visible in FIG. 1, it will be understood from FIG. 2 that the first foot 140a may extend further upwards in the third direction 3 than does the first leg 130a. For example, the first foot 140a may protrude upwards beyond the first leg 130a. Similarly, the second foot 140b may extend further upwards in the third direction 3 than does the second leg 130b. In particular, a top surface of each foot 140a, 140b may align with a top surface of the body elements 120a, 120b (and spine 110), e.g., to further support a cutting tool as will be described below. Alternatively, the feet 140a, 140b may not extend further upwards in the third direction 3 such that the feet 140a, 140b may retract into the respective body element 120a, 120b.

### Slidable Connections

The connections between each of the components above will now be described in greater detail.

The first body element 120a and the second body element 120b each comprise a channel (not shown) extending along the first direction 1. Each channel is configured to receive the spine 110, such as by means of linear (e.g. longitudinal) insertion. For example, each channel may comprise a uniform transverse cross section corresponding to (e.g., matching) that of the spine 110. Upon insertion of the spine 110 in to the channels of the first and second body elements 120a, 120b, the spine 110 may be fixed relative to each of the first and second body elements 120a, 120b along the second direction 2 and/or the third direction 3. In the example shown in FIG. 1, upon insertion of the spine 110 in to the channels of the first and second body elements 120a, 120b, the spine 110 and the first and second body elements 120a, 120b are permitted to slide linearly relative to one another along the first direction 1. In this manner, the first and second body elements 120a, 120b are slidably connected to the spine 110 such that the spine 110, first body element 120a, and second body element 120b are slidable (e.g. continuously slidable) relative to one another along the first direction, while being fixed along the second and third directions 2, 3.

Accordingly, a separation between the first body element 120a and the second body element 120b along the first direction 1 can be varied by linearly sliding the first and/or second body elements 120a, 120b relative to one another. In this way, a first dimension of the opening 150 along the first direction 1 may be adjusted or varied by a user.

The first body element 120a and the second body element 120b each comprise a recess 124a, 124b (FIG. 2) respectively extending therethrough. The recesses 124a, 124b extend parallel with both the first direction 1 and the second direction 2. The recesses 124a, 124b comprise uniform transverse cross sections along each of the three directions. The recesses 124a, 124b extend the full length of the first and second body elements 120a, 120b in the first direction 1 such that the recesses 124a, 124b intersect the uppermost and lowermost aspects of the first and second body elements 120a, 120b along the first direction 1. Accordingly, a continuous passageway is formed through each of the first and second body elements 120a, 120b along the first direction 1. In the example shown in FIG. 1, the recesses do not intersect innermost and outermost aspects of the first and second body elements 120a, 120b along the second direction 2, nor top and bottom surfaces along the third direction 3, such that the recesses 124a, 124b are bounded along the second and third directions 2, 3.

The first recess 124a of the first body element 120a is configured to receive the first leg 130a. Upon insertion of the first leg 130a into the first recess 124a, the first leg 130a is configured to be slidably translatable within the first recess 124a along both the first and second directions 1, 2 (e.g. along the first and second directions 1, 2 independently). Accordingly, upon insertion of the first leg 130a into the first recess 124a, the first leg 130a is slidably translatable relative to the first body element 120a along both the first and second directions 1, 2 (e.g. along the first and second directions 1, 2 independently). For example, the first leg 130a may be continuously and slidably translatable relative to the first body element 120a along each of the first and second directions 1, 2 independently. As shown in FIG. 1, the first leg 130a is greater in length along the first direction 1 than the first recess 124a of the first body element 120a and may thereby protrude both above and below the first recess 124a simultaneously, depending on its position. Accordingly, the first leg 130a is extendable and retractable along the first direction 1 relative to the first body element 120a. In a most retracted position, the first leg 130a may form a contiguous surface with a lowermost aspect of the first body element 120a along the first direction 1. In a most extended position, the first leg 130a may not protrude above the first recess 124a. Additionally or alternatively, in a most extended position, the first leg 130a (e.g., the first foot 140a thereof) may abut the second body element 120b so as to form a rectangularly shaped opening (e.g., in absence of the second leg 130b).

The second recess 124b of the second body element 120b is configured to receive the second leg 130b. Upon insertion of the second leg 120b into the second recess 124b, the second leg 130b is configured to be slidably translatable within the second recess 124b along both the first and second directions 1, 2 (e.g., along the first and second directions 1, 2 independently). Accordingly, upon insertion of the second leg 120b into the second recess 124b, the second leg 130b is slidably translatable relative to the second body element 120b along both the first and second directions 1, 2 (e.g., along the first and second directions 1, 2 independently). For example, the second leg 130b may be continuously and slidably translatable relative to the second body element 120b along each of the first and second directions 1, 2 independently. As shown in FIG. 1, the second leg 130b is greater in length along the first direction than the second body element 120b, and may thereby protrude both above and below the second recess 124b of the second body element 120b simultaneously. Accordingly, the first leg 130a is extendable and retractable along the first direction relative to the second body element 120b. In a most retracted position, the first leg 130a may form a contiguous surface with an uppermost aspect of the second body element 120b along the first direction 1. In a most extended position, the second leg 130b may not protrude above the second recess 124b. Additionally or alternatively, in a most extended position, the second leg 130b (e.g., the second foot 140b thereof) may abut the first body element 120a so as to form a rectangular shaped opening (e.g., in absence of the first leg 130a).

Accordingly, a separation between the first leg 130a and the spine 110 along the second direction 2 can be adjusted (e.g., varied continuously between zero and the length of the first body element 120a along the second direction 2) by sliding the first leg 130a along the second direction 2. Similarly, a separation between the second leg 130b and the spine 110 along the second direction 2 can be adjusted (e.g., varied continuously between zero and the length of the second body element 120b along the second direction 2) by sliding the second leg 130b along the second direction 2. In this way, a second dimension of the opening 150 along the second direction 2 may be adjusted or varied by a user.

Further, a separation between the first foot 140a and the second foot 140b along the first direction 1 can be adjusted (e.g., varied continuously between zero and the separation of the first and second body elements 120a, 120b along the first direction 1) by sliding the first and second legs 130a, 130b along the first direction 1.

In the example shown in FIG. 1, the first and second legs 130a, 130b are adjusted along the second direction 2 such that the first and second legs 130a, 130b are collinear, and adjusted along the first direction 1 such that the first and second feet 140a, 140b abut one another. An opening 150 having a rectangular shape is thereby formed. In the example shown in FIG. 2, the first and second legs 130a, 130b are adjusted along the first direction 1 such that the first and second feet 140a, 140b are spaced apart along the first direction 1, so as to form an opening 250 having a complex shape (e.g., a sideways T-shape). The opening 250 comprises first and second re-entrants (e.g., re-entrant corners or re-entrant angles). Further, the opening 250 comprises no boundary, opposite the spine 110 along the second direction 2, between the first and second feet 140a, 140b. This allows a recess to be formed in the surface that flows over (e.g., intersects) an edge of the surface. It will be understood by the skilled person that this is particularly useful when installing door keeps in door frames.

Accordingly, the first and second legs 130a, 130b may be adjusted along the first direction 1 in order to control a shape and dimensions of the opening 250. In particular, the first leg 130a may be adjusted along the first direction 1 to define the presence or absence, and the dimension along the first direction 1, of the first re-entrant. Similarly, the second leg 130b may be adjusted along the first direction 1 to define the presence or absence, and the dimension along the first direction 1, of the second re-entrant.

For example, one of the first and second legs 130a, 130b may be retracted fully along the first direction 1, and the other of the first and second legs 130a, 130b may be at least partially extended along the first direction 1 so as to define an opening having a first or second re-entrant respectively (termed an L-shaped opening). Alternatively, both the first and second legs 130a, 130b may be at least partially extended along the first direction 1 so as to define first and second re-entrants respectively (termed a T-shaped opening). As a further alternative, the first and second legs 130a, 130b (e.g., the first and second feet 140a, 140b) may be configured to abut one another in any position varying continuously between: the first leg 130a being fully retracted and the second leg 130b being fully extended; and the second leg 130b being fully retracted and the first leg 130a being fully extended (termed a rectangular opening). Alternatively further still, both the first and second legs 130a, 130b may be fully retracted along the first direction 1 so as to define an opening (not shown) having no lateral boundary opposite the spine 110 along the second direction 2 such that the resulting recess may flow over an edge of the surface being cut (termed a three-sided rectangular opening).

The first and second legs 130a, 130b may be adjusted along the second direction 2 to define a dimension of the opening 150 along the second direction 2. In the example shown in FIG. 1, when the first and second legs 130a, 130b (e.g., by means of the feet 140a, 140b thereof) abut one another, the first and second legs 130a, 130b define a width of the rectangular opening 150 along the second direction 2. In the example shown in FIG. 2, when the first and second legs 130a, 130b are spaced apart along the second direction 2 so as to define first and second re-entrants of the opening 250, the first and second legs 130a, 130b define a width of a portion of the opening 250 between the spine 110 and the legs 130a, 130b, as well as a dimension of the first and second re-entrants along the second direction 2.

### Lockable Positions

The spine 110 comprises at least one aperture 112a configured to lock in position the first body element 120a relative thereto. The spine 110 comprises at least one aperture 112b configured to lock in position the second body element 120b relative thereto. For example, as shown in FIG. 1, the spine 110 may comprise a plurality of discrete apertures 112a, 112b distributed (e.g., distributed at regular intervals) along its length. The apertures 112a, 112b may be configured to receive fasteners (not shown) which may pass through the apertures 112a, 112b and be received in a corresponding aperture (not shown) provided within the channels (not shown) of the first and second body elements 120a, 120b beneath. The first and second body elements 120a, 120b may thereby be discretely adjustable along the first direction 1 relative to one another. The first and second body elements 120a, 120b may thereby be continuously slidable relative to the spine 110, but lockable in fixed, discrete positions relative thereto.

Additionally or alternatively, in an example not shown, the spine 110 (or body elements) may comprise one elongate aperture extending longitudinally, through which fasteners may be inserted in continuously variable locations in order to allow for continuous adjustability of each of the first and second body elements 120a, 120b relative to the spine 110. The first and second body elements 120a, 120b may thereby be continuously slidable relative to the spine 110 and lockable in continuously variable positions relative thereto.

In this manner, the first and second body elements 120a, 120b may be locked in position relative to the spine 110 so as to not move or be repositioned during use, such as upon exertion of a cutting force.

As shown in FIGS. 1 and 2, each of the first and second legs 130a, 130b comprises a longitudinally extending channel 134a, 134b respectively. Each of the channels 134a, 134b cooperates with a guide (e.g., fastener described below) to permit adjustment of the first and second legs 130a, 130b in the first direction. The channels 134a, 134b extend through the thickness of the legs 130a, 130b in the third direction 3 and comprise a uniform transverse cross section. The channels 134a, 134b are bounded at their ends along the first direction 1. Each channel 134a, 134b is configured to receive (e.g., slidably receive) at least one fastener 128a, 128b respectively (e.g. a captive screw). The bounded ends of the channels 134a, 134b may thereby restrict the range of slidable travel of the fasteners 128a, 128b.

Each of the first and second body elements 120a, 120b comprises at least one channel (e.g. two parallel channels) 126a, 126b respectively extending in the second direction 2. Each of the channels 126a, 126b cooperates with a guide (e.g., the same guide that cooperates with channels 134a, 134b) to permit adjustment of the first and second legs 130a, 130b in the second direction. The channels 126a, 126b pass through the thickness of a top (along the third direction 3) wall of each body element 120a, 120b, and intersect the recess 124a, 124b therein. Accordingly, a continuous passageway is formed passing from a top (along the third direction 3) surface of each of the first and second body elements 120a, 120b, through the top wall, and into the recesses 124a, 124b. The channels 126a, 126b are configured to receive (e.g., slidable receive) at least one fastener 128a, 128b respectively (e.g., a captive screw).

Upon insertion of the first leg 130a into the first recess 124a, the two parallel channels 126a of the first body element 120a intersect (e.g., intersect perpendicularly), along the third direction 3, the longitudinally extending channel 134a of the first leg 130a, such that a continuous passageway (along the third direction 3) is formed from the top (along the third direction 3) surface of the first body element 120a passing through the channel 126a and through the recess 124a in to the longitudinal channel 134a. A fastener 128a may be passed through one or each of the two parallel channels 126a and into the longitudinal channel 134a of the first leg 130. In this manner, the fastener 128a may lock the first leg 130a in position relative to the first body element 120a along both the first and second directions 1, 2. In particular, the two parallel channels 126a extending along the second direction 2 provide adjustability and lockability of the first leg 130a within the first body element 120a along the second direction 2, while the longitudinally extending channel 134a of the first leg 130a provides adjustability and lockability of the first leg 130a within the first body element 130a along the first direction 1. The position of the first leg 130a relative to the first body element 120a may thereby be adjusted along the first direction 1 independently of its position along the second direction 2, and further may be adjusted along the second direction 2 independently of its position along the first direction 1.

For conciseness, it will be understood that a respective arrangement is provided for the second leg 130b, the second recess 124b, the two parallel channels 126b, the channel 134b, and the fastener 128b. The position of the second leg 130b relative to the second body element 120b may thereby be adjusted along the first direction 1 independently of its position along the second direction 2, and further may be adjusted along the second direction 2 independently of its position along the first direction 1.

The jig 100 comprises at least one means for fixing (e.g., temporarily and/or removably and/or rigidly attaching) the jig 100 to the surface within which a recess is to be cut. In the example shown in FIGS. 1 and 2, the jig 100 comprises at least two apertures 122a, 122b for receiving fasteners (not shown) to fix the jig 100 to the surface in which the recess is to be cut. In particular, the first and second body elements 120a, 120b comprise first and second flanges 121a, 121b respectively, extending therefrom in the plane of the first and second directions 1, 2 and flush with a bottom (along the third direction 3) surface (not shown) of the first and second body elements 120a, 120b, such that upon placing the jig 100 against a surface, the first and second flanges 121a, 121b are configured to abut the surface. As shown in FIG. 2, the first and second flanges 121a, 121b extend above and below (along the first direction 1) the first and second body elements 120a, 120b respectively such that the flanges 121a, 121b may abut the narrow surface of the door jamb 14 when the jig 100 is placed against the door jamb 14. The first flange 121a comprises a first aperture 122a, and the second flange 121b comprises a second aperture 122b, each aperture 122a, 122b being configured to receive a fastener (e.g., screw, not shown) which may be driven in to the surface (e.g., door jamb 14) upon which the jig 100 is to be used. Additionally or alternatively, the jig 100 may comprise a means (not shown) for being clamped to the door frame 10, e.g., a door stop of the door frame.

### Use in Cutting a Recess

With reference to FIG. 2, use of the jig 100 is described in the context of forming a recess in a door frame 10. The door frame 10 shown in FIG. 2 may be provided on an opposing side of the door frame 10 on which door hinges are provided. The door frame 10 comprises a door stop 12 having a shoulder or side surface 16 against which the door (not shown) may rest upon closing. The door frame 10 further comprises a door jamb 14 within which the recess is to be cut for receiving the lock keep, the door jamb 14 comprising a side surface 18.

In use, the first and second body elements 120a, 120b and the first and second legs 130a, 130b may be adjusted in order to define an opening 150, 250 having a desired shape and desired dimensions.

In particular, the first and second body elements 120a, 120b may be adjusted along the first direction 1, relative to one another and the spine 110, in order to define a first dimension of the opening 150, 250 along the first direction 1. The first and/or second legs 130a, 130b may be adjusted along the first and second directions 1, 2 so as to define an opening 150, 250 having a desired shape and desired dimensions. For example, as described above, the first and/or second legs 130a, 130b may be adjusted along the first direction 1 so as to define a shape of the opening 150, 250 from one of: rectangular; L-shaped; T-shaped; and three-sided rectangular, openings. The first and second body elements 120a, 120b, and the first and second legs 130a, 130b may then be locked in place relative to one another using the locking features (e.g., fasteners 112a, 112b, 128a, 128b) described above.

For example, in order to set the dimensions and shape of the opening 150, 250 in order to form a recess in a door frame for receiving a door keep 500 (FIG. 5), the door keep 500 may be placed (not shown) in the opening 150, 250, and the body elements 120a, 120b and the legs 130a, 130b may be slid together until each component abuts an edge of the door keep 500. The components may then be locked in place using the locking features described above. Depending on the cutting tool being used (e.g., depending on its ability to negotiate re-entrants), the dimensions of the opening 150, 250 may be increased marginally (e.g., 2 mm or 4 mm in each direction) so as to accommodate the minimum cutting accuracy. For example, the cutting part of a router may be set back by a small distance (e.g., 2 mm) from a running surface of the router such that the dimensions of the opening 150, 250 may need to be increased by twice that small distance in each dimension in order to form a recess of the lock keep dimensions.

Upon locking the components in place to form a locked opening 150, 250, the door keep may then be removed from the opening 150, 250. The jig 100 may then be placed against a surface within which a recess is to be cut. For example, as shown in FIG. 2, the jig 100 may be placed against the surfaces of the door frame 10. In particular, the bottom (along the third direction 3) surfaces (not shown) of the first and second body elements 120a, 120b are configured to be placed against the surface of the door jamb 14 within which the recess is to be cut. A lateral (in the second direction 2) surface (not shown) of each the first and second body elements 120a, 120b may be configured to abut the side surface 16 of the door stop 12 of the door frame 10.

Optionally, a bottom (along the third direction 3) surface (not shown) of the spine 110 may be configured to be placed against a surface of the door stop 12 such that the bottom surfaces of the spine 110 and the first and second body elements 120a, 120b may abut surfaces of the door frame 10 that are spaced apart in the third direction 3.

The jig 100 may then be fixed to the door frame 10. For example, fasteners (e.g., screws) may be passed through apertures 122a, 122b and driven in to the door jamb 14. A cutting tool, (e.g., a power cutting tool such as a router), may have its cutting depth set to the thickness (in the third dimension 3) of the jig 100 by pressing a supporting surface (not shown) of the cutting tool against the jig 100 (e.g., the top surfaces of the spine 110 and the first and second body elements 120a, 120b) and the cutting element against the door jamb 14. The cutting depth can be set to accommodate the thickness of the door keep by increasing the cutting depth by the thickness of the door keep. This may be done using a fine adjustment mechanism provided on the cutting tool.

The boundaries of the opening 150, 250 may then be used to guide the cutting tool (not shown) in order to form a recess having desired dimensions and a desired shape. In particular, the cutting tool may be guided around the internal perimeter of the opening 250, using the internal perimeter of the opening 250 as a guiding surface. In particular, the internal boundaries (along the first and second directions 1, 2) of the spine 110, the first and second body elements 120a, 120b, the first and second legs 130a, 130b, and the first and second feet 140a, 140b may provide a continuous guiding surface for the cutting tool. The top (along the third direction 3) surfaces of the spine 110, and the first and second body elements 120a, 120b may provide a flat planar running surface against which a supporting surface of the cutting tool may be pressed. The top (along the third direction 3) surfaces of the legs 130a, 130b and the feet 140a, 140b may not provide a running surface for the cutting tool (e.g., only a guiding surface).

As shown in FIG. 3, a recess 300 having dimensions corresponding to (e.g., matching or closely matching according to the cutting tolerances) those of the opening 250 may thereby be formed. The depth of the recess 300 may be uniform and equal to the thickness of the door keep. Depending on the cutting tool used (e.g., cutting tolerances and accuracies thereof), and formed in FIG. 3 using a router, the recess 300 may have rounded corners. These can be removed simply using a right-angled chisel (not shown). The jig 100 may then be removed from the door jamb 14, for example by unscrewing the screws in the apertures 122a, 122b.

As shown in FIG. 4, upon removal of the jig 100 from the door frame 10, a recess 300 is formed, and two holes 404a, 404b within the door jamb 14 may be present. The holes 404a, 404b can be removed simply by filling, sanding, and painting.

The door keep 500 may then be inserted and fitted within the recess 300. As shown in FIG. 5, a neat finish in which the surface of the door keep sits flush with the surface of the door jamb 14 may thereby be achieved.

The skilled person will understand that the jig 100 may be used in a similar manner in order to form the internal sub-recess 400 (FIG. 4) within the main recess 300, the internal sub-recess being configured to receive the latch or lock element of the door latch or lock assembly. For example, the position of the jig 100 may be adjusted laterally such that the edge of the spine 110 may again define an edge of the recess being cut.

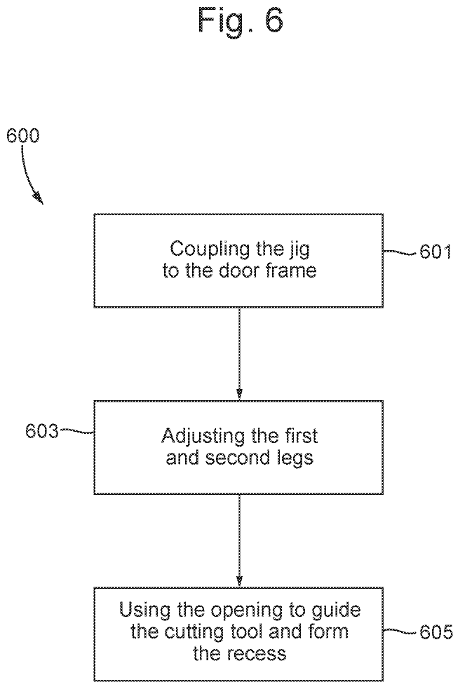

With reference to FIG. 6, a method 600 of forming a recess 300 for a door keep 500 in a door frame 10 is described. The method 600 comprises, at 601, coupling the door keep jig 100 to a door frame 10. For example, the jig 100 may be either fastened to the door frame 10, using fasteners, or clamped to the door frame 10.

The method 600 further comprises, at 603, adjusting the first and second legs 120a, 120b so that the opening 150, 250 corresponds to the desired dimensions and shape of the recess 300 for receiving the door keep 500.

At 605, the method 600 comprises using the opening 150, 250, defined by at least the spine 110, the first and second body elements 130a, 130, and the first leg 130a, to guide a cutting tool and form a recess. As described above, the opening may be further defined by the first foot 140a and/or the second leg 130b which may optionally comprise the second foot 140b. The cutting tool may be guided around the internal perimeter of the opening 150, 250.

The method 600 may additionally comprise inserting a door keep 500 within the opening 150, 250 of the jig 100, for example so as allow easy adjustment of the slidable components of the jig 100 to the dimensions of the door keep.

The method 600 may additionally comprise: setting the separation of the first and second body elements 120a, 120b such that the first dimension of the opening 150, 250 corresponds to a height of the door keep; setting the separation of the first leg 130a and the spine 110 such that a second dimension of the opening corresponds to a width of the door keep; setting the separation of the second leg 130b and the spine 110 such that a second dimension of the opening corresponds to a width of the door keep; and/or setting a separation of the first and second feet 140a, 140b so as to define a shape and further dimension of the opening 150, 250.

The method may additionally comprise locking the jig components in place, e.g., using fasteners 112a, 112b, 128a, 128b; fixing the jig 100 to the surface of a door jamb 14; and cutting a recess in the surface of the door jamb 14.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An adjustable door keep jig for use in cutting a recess for a door keep in a door frame, the door keep jig comprising:
a spine extending in a first direction;
a first body element and a second body element each being connected to the spine and each extending away from the spine in a second direction, the first and second body elements being spaced apart from one another;
a first leg slidably connected to the first body element and extending from the first body element toward the second body element in the first direction, the first leg being slidably adjustable relative to the first body element in both the first and second directions; and
a second leg slidably connected to the second body element and extending from the second body element toward the first body element in the first direction, the second leg being slidably adjustable relative to the second body element in both the first and second directions,
wherein the spine, the first and second body elements, and the first and second legs define therebetween an opening, the opening providing a guide for a cutting tool to form the recess in a surface of the door frame when the door keep jig is placed against the surface of the door frame within which the recess is to be cut.

2. The door keep jig of claim 1, wherein the first and second body elements are slidably adjustable along the spine in the first direction.

3. The door keep jig of claim 1, wherein at a proximal end of the first leg, the first leg includes a first foot extending away from the spine in the second direction, and/or at a proximal end of the second leg, the second leg includes a second foot extending away from the spine in the second direction.

4. The door keep jig of claim 1, wherein the first leg is slidably adjustable relative to the first body element along the first and second directions independently, and/or the second leg is slidably adjustable relative to the second body element along the first and second directions independently.

5. The door keep jig of claim 1, wherein the first and second legs are slidably adjustable independently of one another.

6. The door keep jig of claim 1, wherein the opening includes a re-entrant.

7. The door keep jig of claim 3, wherein the first foot and the first leg are configured to define a first re-entrant of the opening.

8. The door keep jig of claim 3, wherein the second foot and the second leg are configured to define a second re-entrant of the opening.

9. The door keep jig of claim 1, wherein the first and second body elements are configured to be spaced apart along the first direction to define a first dimension of the opening, and wherein the first leg is configured to be spaced apart from the spine in the second direction to define a second dimension of the opening.

10. The door keep jig of claim 3, wherein a separation between the first and second feet along the first direction is configured to be continuously variable between zero and a separation between the first and second body elements along the first direction.

11. The door keep jig of claim 3, wherein the first foot and/or the second foot is configured to define a shape of the opening and a further dimension of the opening.

12. The door keep jig of claim 1, wherein the first and second body elements are lockable relative to the spine, and wherein the first leg is lockable relative to the first body element; and/or wherein the second leg is lockable relative to the second body element.

13. The door keep jig of claim 3, wherein the first foot is rigidly attached to the first leg and/or the second foot is rigidly attached to the second leg.

14. The door keep jig of claim 1, wherein the jig is configured to be coupled to the door frame.

15. The door keep jig of claim 14, wherein each of the first and second body elements includes an aperture for receiving a fastener for fixing the jig to the door frame.

16. The door keep jig of claim 1, wherein the first and second body elements are continuously adjustable relative to the spine and/or the first and second legs are continuously adjustable relative to the first and second body elements respectively.

17. The door keep jig of claim 3, wherein upon coupling to the doorframe, at least one of the first and second feet is configured to extend away from the spine in the second direction and beyond an edge of the door frame.

18. The door keep jig of claim 1, wherein the jig is configured to form a recess intersecting an edge of the door frame.

19. The door keep jig of claim 1, wherein the jig is configured to be placed against the door frame so as to extend across the stop and the jamb of the door frame.

20. A method of forming a recess for a door keep in a door frame, the method comprising the steps of:
coupling the door keep jig according to claim 1 to the door frame;
adjusting the first and second legs so that the opening corresponds to the door keep; and
using the opening defined by at least the spine, the first and second body elements, and the first leg, to guide the cutting tool and form the recess.
